(19) United States
(12) Patent Application Publication
(10) Pub. No.: US 2026/0100076 A1
(43) Pub. Date: Apr. 9, 2026

(54) ELECTRIC VEHICLE LOAD BALANCING THROUGH INDICATOR CONTROL

(71) Applicant: ADDÉNERGIE TECHNOLOGIES INC., Québec City (CA)

(72) Inventor: Kevin BÉLISLE, Lévis (CA)

(73) Assignee: ADDÉNERGIE TECHNOLOGIES INC., Québec City (CA)

(21) Appl. No.: 18/908,889

(22) Filed: Oct. 8, 2024

(51) Int. Cl. G07C 5/08; B60K 35/21

(52) U.S. Cl. CPC G07C 5/0825; B60K 35/21; B60K 2360/16

(57) ABSTRACT

An electric vehicle charging system (EVCS) for load balancing by directing the placement of electric vehicles requiring access to electrical supply charging equipment (EVSE) to one or more of the EVSE using one or more indicators in proximity to the EVSE. One or more controllers may be configured to select one or more of the EVSE to be used by a next electric vehicle requiring access to one of the EVSE by identifying the one or more EVSE whose use will manage a load across the plurality of electrical supply components and control one or more of the one or more indicators to indicate that the selected one or more of the EVSE is to be used by the next vehicle requiring access to one of the EVSE.

### FIELD

This application relates to electric vehicle charging stations. More particularly, systems, methods, and techniques for electric vehicle load balancing.

### BACKGROUND

An electric vehicle charging station is an element of infrastructure that supplies direct current (DC) or alternating current (AC) electric energy for the recharging of electric vehicles, such as plug-in battery electric vehicles, including electric cars, trucks, buses, and other vehicles including high and low range electric vehicles and plug-in hybrids.

Often, a number of electric vehicle supply equipment (EVSE), also referred to as electric vehicle charging stations, are connected to breakers, subpanels or electrical phases which are insufficient to deliver full power to all of the EVSEs connected to such components if all of the EVSE were to be used at full capacity. One or more controllers, such as a site controller, may coordinate the sharing of electrical power by the various EVSE in an attempt to avoid overload conditions.

In some instances, EVs may be arranged for charging in arrangements that do not fully optimize site conditions. For example, multiple EVs may be connected to EVSEs that are associated with a particular component, such as a particular breaker, subpanel, or electrical phase, and no EVs may be connected to any EVSEs that are associated with another particular component, such as a particular breaker, subpanel or electrical phase.

In some installations, in order to avoid overload conditions, the infrastructure may be designed so that all components have a large excess capacity. This may result in infrastructure inefficiencies and may increase installation costs.

### BRIEF DESCRIPTION OF THE DRAWINGS

Reference will now be made, by way of example, to the accompanying drawings which show example embodiments of the present application. In the drawings:

FIG. 1 is a simplified diagram of an electric vehicle charging system (EVCS) in accordance with an example of the present application.

FIG. 2 is a perspective view of an electric vehicle supply equipment (EVSE) of FIG. 1.

FIG. 3 is a side view of the EVSE of FIG. 2.

FIG. 4 is an enlarged view of an indicator of the EVSE of FIG. 2.

FIG. 5 shows an illustrative method for electric vehicle load balancing.

FIG. 6 shows an example where electric vehicle load balancing may be activated.

Like reference numerals are used in the drawings to denote like elements and features.

### DETAILED DESCRIPTION OF EXAMPLE EMBODIMENTS

In one aspect, the present application describes an electric vehicle charging system. The electric vehicle charging system may include a plurality of electric vehicle supply equipment (EVSE). The plurality of electric vehicle supply equipment (EVSE) may be coupled to a plurality of electrical supply components. The electric vehicle charging system may include one or more controllers coupled to the plurality of EVSE. The electric vehicle charging system may include one or more indicators for indicating one or more of the plurality of EVSE that are to be used by a next electric vehicle requiring access to one of the plurality of EVSE. The one or more controllers may be configured to select one or more of the plurality of EVSE to be used by the next electric vehicle by identifying the one or more of the plurality of EVSE whose use will manage a load across the plurality of electrical supply components. The one or more controllers may be configured to control the one or more indicators to indicate that the one or more of the plurality of EVSE is to be used by the next electric vehicle.

In some implementations, the one or more indicators may be for indicating one or more of the plurality of EVSE that are to be used by the next electric vehicle.

In some implementations, the one or more indicators may include one or more lights. Each of the one or more lights may be situated in proximity and associated with a separate one of the plurality of EVSE.

In some implementations, controlling the one or more indicators may include adjusting a brightness of the one or more indicators so that the one or more lights associated with selected one or more of the plurality of EVSE is relatively brighter than the one or more lights associated with non-selected one or more of the plurality of EVSE.

In some implementations, controlling the one or more indicators may include adjusting a color of the one or more indicators so that the one or more lights associated with selected one or more of the plurality of EVSE has a first color that distinguishes from a second color of the one or more lights associated with non-selected one or more of the plurality of EVSE.

In some implementations, each of the one or more indicators may be situated in proximity and associated with a separate one of the plurality of EVSE. In some implementations, controlling the one or more indicators may include causing the one or more indicators associated with selected one or more of the plurality of EVSE to display an animation that animates at a greater rate than a corresponding animation displayed on non-selected one or more of the plurality of EVSE.

In some implementations, identifying the one or more EVSE whose use will manage a load across the plurality of electrical supply components may include identifying a breaker having a greatest available load based on current load data and identifying an EVSE associated with an identified breaker that is available for use based on system configuration data.

In some implementations, identifying the one or more EVSE whose use will manage a load across the plurality of electrical supply components may include identifying a sub-panel having a greatest available load based on current load data and identifying an EVSE associated with an identified sub-panel that is available for use based on system configuration data.

In some implementations, identifying the one or more EVSE whose use will manage a load across the plurality of electrical supply components may include identifying a phase having a greatest available load based on current load data and identifying an EVSE associated with an identified phase that is available for use based on system configuration data.

In some implementations, the one or more indicators may be in a cabin of the next electric vehicle.

In another aspect, the present application describes a computer-implemented method for load balancing. The method may comprise selecting one or more electric vehicle supply equipment (EVSE) to be used by a next electric vehicle requiring access to the one or more EVSE by identifying the one or more EVSE whose use will manage a load across a plurality of electrical supply components. The method may comprise controlling one or more indicators to indicate that the one or more EVSE are to be used by the next electric vehicle.

In some implementations, the method may include the one or more indicators for indicating the one or more EVSE that are to be used by the next electric vehicle.

In some implementations, the one or more indicators may include one or more lights, each of the one or more lights situated in proximity and associated with a separate one of the one or more EVSE.

In some implementations, controlling the one or more of the indicators may include adjusting a brightness of the one or more indicators so that the one or more lights associated with selected one or more EVSE is relatively brighter than the one or more lights associated with non-selected one or more EVSE.

In some implementations, controlling the one or more indicators may include adjusting a color of the one or more indicators so that the one or more lights that is associated with selected one or more EVSE has a first color that distinguishes from a second color of the one or more lights associated with non-selected one or more EVSE.

In some implementations, each of the one or more indicators may be situated in proximity and associated with a separate one of the EVSE. In some implementations, controlling the one or more indicators may include causing the one or more indicators associated with selected EVSE to display an animation that animates at a greater rate than a corresponding animation displayed on non-selected EVSE.

In some implementations, identifying the one or more EVSE whose use will manage a load across the plurality of electrical supply components may include identifying a breaker having a greatest available load based on current load data and identifying an EVSE associated with an identified breaker that is available for use based on system configuration data.

In some implementations, identifying the one or more EVSE whose use will manage a load across the plurality of electrical supply components may include identifying a sub-panel having a greatest available load based on current load data and identifying an EVSE associated with an identified sub-panel that is available for use based on system configuration data.

In some implementations, identifying the one or more EVSE whose use will manage a load across the plurality of electrical supply components may include identifying a phase having a greatest available load based on current load data and identifying an EVSE associated with an identified phase that is available for use based on system configuration data.

In some implementations, the one or more indicators may be in a cabin of the next electric vehicle.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of …or…” is intended to cover any one or more of the listed elements, including any one of the listed elements alone, any sub-combination, or all of the elements, without necessarily excluding any additional elements, and without necessarily requiring all of the elements.

Generally, several electric vehicle supply equipment, also known as charging stations, are connected to electrical supply components and electrical distribution equipment which include breakers, subpanels, or electrical phases. The electrical distribution equipment may be insufficient to deliver full power to all the charging stations connected to it. Accordingly, an enhanced charging experience may be achieved by having electric vehicles equally or selectively distributed across the various breakers, subpanels, or electrical phases as customers, i.e., electric vehicle drivers, typically choose charging stations based on convenience. Thus, the most optimal charging station is not usually selected.

The present application involves controlling indicators, such as lights or other visual indicators, to indicate which of the available charging stations should be used. When a customer uses the selected charging station, power may be delivered to the electric vehicle more quickly than if the customer uses a charging station other than the selected charging station. For example, the selected charging station may be connected to a less loaded breaker, subpanel, or electrical phase.

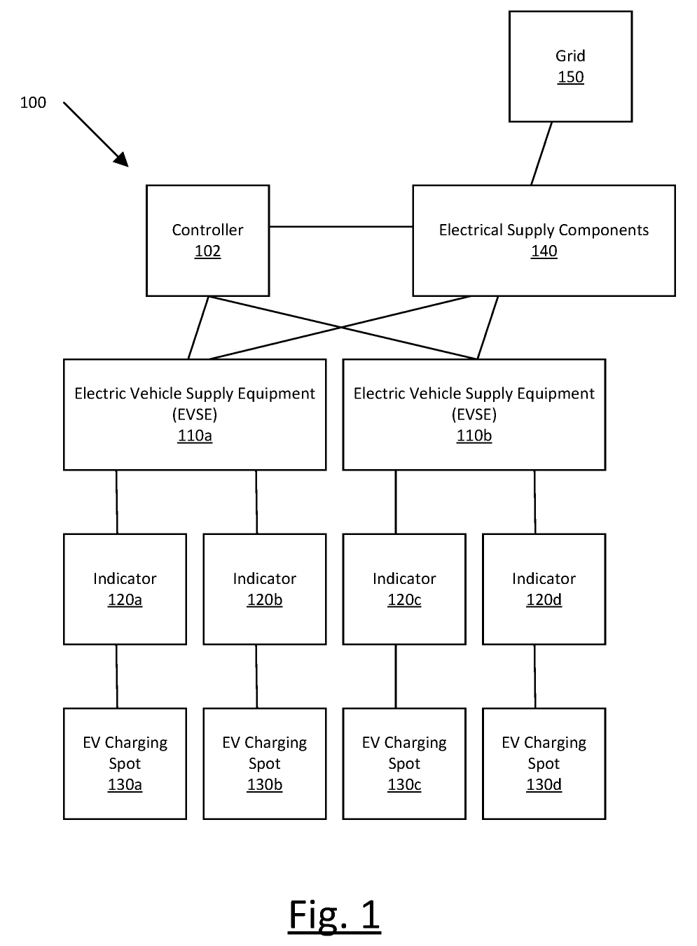

Reference is now made to FIG. 1 which illustrates an electric vehicle charging system (EVCS) 100. The EVCS 100 may include a plurality of electric vehicle supply equipment (EVSE) 110a, 110b also referred to as charging stations. The plurality of EVSE 110 may be used for providing electrical energy to electric vehicles (EVs). The EVCS 100 may include a plurality of electrical supply components 140.

The plurality of electrical supply components 140 may include electrical distribution equipment. The plurality of electrical supply components 140 may include breakers, subpanels, or electrical phases. The plurality of electrical supply components 140 may be connected to the electrical grid 150.

The EVCS 100 may include a communications module (not shown). The EVCS 100 may include a memory module (not shown). The EVCS 100 may have architecture data regarding the electrical supply components 140, such as the parameters for the breakers, subpanels, or electrical phases. The architecture data may be stored in the memory module of the EVCS. The architecture data may include the power output of the plurality of EVSE 110. For example, the architecture data may include the electrical power assigned to the plurality of EVSE. The architecture data may include information regarding each of the EVSE of the plurality of EVSE 110 that are on underutilized phases, subpanels, or electrical phases.

The EVCS 100 may include one or more controllers 102. The one or more controllers 102 may include a site controller. The one or more controllers 102 may utilize the architecture data stored in, for example, the memory module. The one or more controllers 102 may determine which one of the plurality of EVSE are underutilized by the breakers, subpanels or electrical phases. The one or more controllers 102 may select and deselect one or more of the plurality of EVSE 110 to be used by a next EV requiring access to an EVSE based on the architecture data. The one or more controllers 102 may activate or deactivate the one or more indicators 120 based the selection of the plurality of EVSE 110. In some implementations, the site controller may be situated in one of the EVSE 110.

The one or more controllers 102 may be coupled to the plurality of EVSE 110. The one or more controllers 102 may be configured to analyze the plurality of EVSE 110. The one or more controllers 102 may be coupled to the plurality of electrical supply components 140. The one or more controllers 102 may be configured to analyze the plurality of electrical supply components 140. The one or more controllers 102 may be coupled to the one or more indicators 120. The one or more controllers 102 may be housed in the same enclosure as the EVCS 100. The one or more controllers 102 may be housed in the same enclosure as one of the plurality of EVSE 110. In some cases, the one or more controllers 102 may be provided on a control circuit. The one or more controllers 102 may include a site controller, a charge point controller, a power conversion controller, a communication controller, an authentication controller, a monitoring and controller system controller, and a grid integration controller. For example, the charge point controller may be used for controlling the flow of power to an EV connected to an EVSE. In some cases, the one or more controllers 102 may be connected to each other and share data. The one or more controllers 102 may be connected to the communications module. The one or more controllers 102 may be connected to the memory module.

The one or more controllers 102 may be coupled to one or more sensors (not shown). The one or more sensors may be included in the plurality of EVSE 110. The one or more sensors may be coupled to the electrical supply components 140. The one or more sensors may monitor the electrical parameters of the electrical supply components 140. The one or more sensors may include one or more of current transformers, Hall effect sensors, shunt resistors, power meters, energy meters, temperature sensors and voltage sensors. The one or more controllers 102 may monitor the EVCS 100 by aggregating data from the one or more sensors. The one or more controllers 102 may determine the flow of energy to an EV connected to the plurality of EVSE 110.

The one or more controllers 102 may be connected to and control the one or more indicators 120. The one or more indicators 120 may include one or more lights in proximity to the plurality of EVSE 110. For example, each indicator 120a, 120b, 120c, 120d may be mapped to or associated with each EV charging spot 130a, 130b, 130c, 130d, respectively. For example, the indicator 120a may be a light indicator and flash green to alert a customer in an EV to proceed to the EV charging spot 130a. In some cases, the other indicators 120b, 120c, 120d may be displaying a different color, such as red.

In some implementations, the EVCS 100 may include a remote server (not shown). Instead of using the one or more controllers 102 at the site or location of the plurality of EVSE 110, the remote server may perform the same function as the one or more controllers 102 or the site controller and wirelessly send the instructions to the plurality of EVSE 110, the one or more controllers 102, or the one or more indicators 120. For example, the remote server may utilize the architecture data. The remote server may determine which one of the plurality of EVSE are underutilized by the breakers, subpanels or electrical phases. The remote server may select and deselect one or more of the plurality of EVSE 110 to be used by a next EV requiring access to an EVSE based on the architecture data. The remote server may activate or deactivate the one or more indicators 120 based the selection of the plurality of EVSE 110.

The plurality of electrical supply components 140 may be coupled to the plurality of EVSE 110. The plurality of electrical supply components 140 may include parts or devices used for the distribution, control, and conversion of electrical power within the EVCS 100. For example, the plurality of electrical supply components 140 may include transformers, circuit breakers and fuses, wires and cables, switches and relays, connectors and terminals, power supply units, capacitors and inductors, control panels and distribution boards. The plurality of EVSE 110 and the electrical supply components 140 may be configured differently for each EVCS 100 based on various environmental factors and the electrical grid 150.

The plurality of electrical supply components 140 may be connected to a power supply, such as from the electrical grid 150. For example, the electrical supply components 140 may be connected to the power lines or underground cables. The electrical supply components 140 may be connected to a power distribution panel or electrical panel. The electrical supply components 140 may be connected to a subpanel.

The plurality of EVSE 110a, 110b may be used to supply one or more EVs with electrical energy. The plurality of EVSE 110 may also be connected, attached, or coupled to the electrical supply components 140 to receive the electric power to provide the one or more EVs.

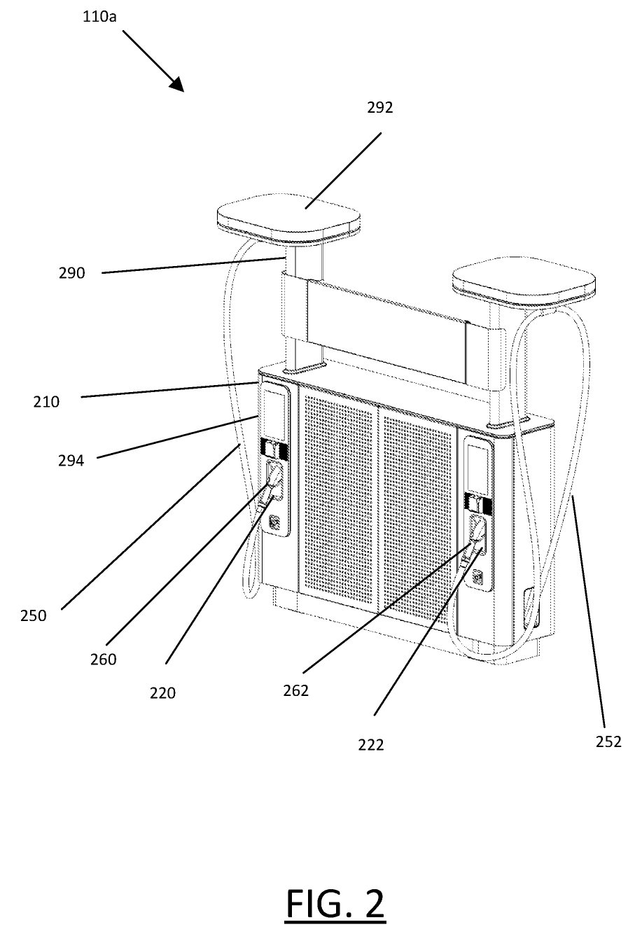

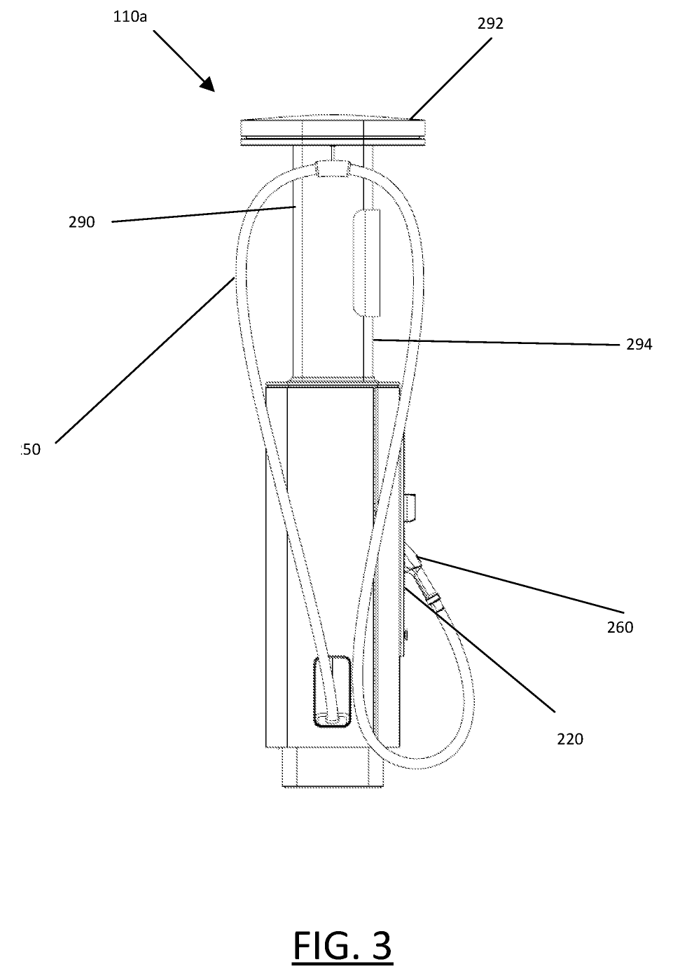

Reference is made to FIGS. 2 and 3, which illustrate an electric vehicle supply equipment (EVSE) 110a in both perspective (FIG. 2) and left side (FIG. 3) views. The EVSE 110a may also be referred to as a charging station. The EVSE 110a may include one or more EV chargers. In the illustrated example, the EVSE 110a includes two EV chargers – a first EV charger 220 and a second EV charger 222. In other implementations, the EVSE 110a may include a greater or lesser number of EV chargers than the EVSE 110a of FIGS. 2 and 3.

Each of the EV chargers 220, 222 may allow the EVSE 110 to concurrently charge a separate EV. For example, an EVSE having two EV chargers may concurrently charge two EVs, an EVSE having three EV chargers may concurrently charge three EVs, and so on.

The EV chargers may be of various types including, for example, any one or more of Level 1 chargers, Level 2 chargers, Level 3 chargers, DC Fast chargers (DCFC), Level 4 chargers, and so on. In one implementation, the EVSE may include an EV charger that charges an EV at 400 volts or more.

The EVSE 110 may be installed at any one or more of: a residence, a business, a parking facility, or in an operating environment of another type. In at least one implementation, the EVSE 110 may be a roadside EV charging station.

Each of the EV chargers 220, 222 may include a charging cable 250, 252. For example, a first EV charger 220 may include a first charging cable 250 and a second EV charger 222 may include a second charging cable 252.

Each of the EV charging cables 250, 252 may, at one end, include a connector 260, 262. For example, the first EV charging cable 250 may include a first connector 260 and the second EV charging cable 252 may include a second connector 262. The first and second connectors 260, 262 may be of the same type or of different types. The connectors 260, 262 are configured to connect the EV chargers to an EV. More specifically, the connectors 260, 262 are configured to mate with a charging port of an EV. The connectors 260, 262 may be configured according to standards such as, for example CHAdeMO standards and/or SAE Combo standards. In some implementations, the connectors 260, 262 may be of one or more of the following types: Port J1772, CHAdeMO, SAE Combo CCS, Tesla HPWC and Tesla Supercharger.

An operator may use the EVSE 110a to charge an EV by extending one of the charging cables 250, 252 until one of the connectors 260, 262 can be aligned with the charging port of the EV. Then, the operator may plug the connector 260, 262 into the charging port and the EVSE 110a will initiate charging of a battery of the EV.

The charging cable 250, 252 may, in at least some implementations, be relatively long and/or relatively thick. A long charging cable 250, 252 allows an operator greater flexibility for positioning their EV in a way that allows for physical connection between the connector 260, 262 and the charging port. In some implementations, the charging cable may be 10 feet or greater in length. In some implementations, the charging cable may be at least 12 feet long. In some implementations, the charging cable may be at least 20 feet long.

The thickness of the charging cable may, in some implementations, allow for high-speed charging of the EV. For example, a thicker charging cable may carry thicker wires or it may have a greater number of conductors than a relatively thinner charging cable which may allow the charging carry to deliver more power to the EV in order to reduce the charge time.

The length and/or thickness of the charging cable may make the charging cable 250, 252 difficult to use for at least some operators. For example, the charging cable may be relatively heavy and an operator may find it difficult to extend the charging cable to allow for connection of the connector 260, 262 and the charging port of an electric vehicle. In order to make the charging cable easier to extend or retract, the EVSE 110a may include one or more cable management systems.

The cable management system or a portion of the cable management system may be housed in the enclosure 210 or a portion thereof. The enclosure 210 may include multiple parts. For example, the enclosure 210 may include a support 290, an upper housing 292 and a lower housing 294. The support 290 may be a columnar support. The support 290 may house one or more components of the EVSE 110a such as one or more electrical wires providing power and/or communications to components housed within the upper housing 292. In some implementations, one or more such electrical wires may provide communications between components housed within the upper housing 292 and components housed within the lower housing 294.

The support 290 may support the upper housing 292 so that the upper housing remains fixed relative to one or both of the support 290 and the lower housing 294. The support 290 may hold the upper housing 292 in a generally horizontal orientation so that the upper housing 292 acts as a canopy or shade. The upper housing 292 may house the cable management system or a portion thereof. In some implementations, the upper housing may house portions of the cable management system. Conveniently, by including the cable management system within the upper housing 292, the cable management system may operate efficiently and/or may require a comparatively short mechanical wire. In at least some implementations, the mechanical wire may have a length that varies due to various operational factors, such as temperature, an amount of force applied to the cable, etc. Reducing the length of the mechanical wire may reduce such variability.

The upper housing 292 may be supported overhead of an operator. For example, the upper housing may be seven feet or more above ground. In at least some implementations, the upper housing 292 may act as or be referred to as a canopy.

The upper housing 292 may be generally horizontal when supported by the support 290. The upper housing 292 may serve a number of functions. For example, it may protect components of the cable management system from the elements, may provide shade or shelter to a user of the EVSE 110a and/or it may provide an offset so that the mechanical wire is extended from and retrieved within a location that is offset from one or more of the support 290 and the lower housing 294. In this way, the upper housing 292 may provide overhead cable management. In some implementations, the upper housing 292 may include one or more visual indicators such as one or more lights. The visual indicators may be controlled to indicate, for example, whether a particular one of the EV chargers is in service, in use, available, etc.

In at least some implementations, each of the EV chargers 220, 222 may include or be associated with a separate indicator which indicates whether that EV charger 220, 222 is to be used. In at least some implementations, each of the EV chargers 220, 222 may include or be associated with a separate lighting canopy, such as a separate upper housing 292 which includes a light. The lighting canopy may be activated to indicate whether or not the associated one of the EV chargers 220, 222 is to be used.

As noted, certain adaptations and modifications of the described embodiments can be made. Therefore, the above discussed embodiments are considered to be illustrative and not restrictive.

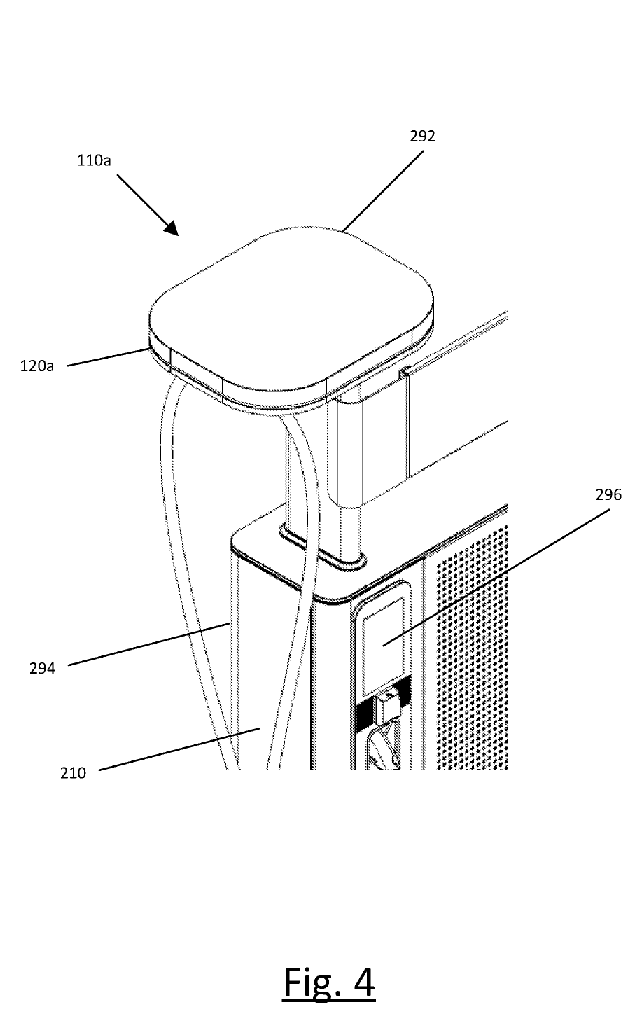

Reference is now made to FIG. 4 which illustrates an example of an indicator 120a. The one or more indicators 120 as shown in FIG. 1 may be used for indicating which one or more EVSE 110 are to be used next by an EV requiring access to an EVSE. The one or more indicators 120 may be controlled by the one or more controllers 102 as shown in FIG. 1. The indicator 120a may be installed on the enclosure 210 of the EVSE 110a. The indicator 120a may be installed on the upper housing 292. The indicator 120a may be installed on the lower housing 294. In some cases, one or more indicators 120 may be installed on the EVSE 110a to provide more visibility to the customer. For example, the indicator 120a may be a light that surrounds the side of the upper housing 292.

The one or more indicators 120 may include lights and/or sounds. For example, a selected EVSE may display a green light on the indicator 120a and a non-selected EVSE may display a red, yellow, or orange light on the indicator thereof. In some implementations, a particular color may indicate an EVSE (and/or charger) that is to be used while another color may indicate and EVSE (and/or charger) that is not to be used. In some cases, the selected EVSE may emit a sound at a certain decibel to notify a customer of an EVSE and/or charger that is to be used. The lights may include LED indicator lights. In some implementations, the lights may include area lights, canopy lights, pedestal lights, and pathway lights. For example, in some implementations, in-ground lighting may be used to route a customer to an EVSE and/or charger that is to be used.

In some implementations, the EVSE may have an indicator associated with each charger included in that EVSE. For example, an EVSE may include a first indicator associated with a first EV charger and a and a second indicator associated with a second EV charger. The first EV charger may not have the same electrical output as the second EV charger. Thus, in some cases, the first indicator may be active as the first EV charger is selected of the EVSE and the second indicator may be inactive as the second EV charger is not selected for use by the one or more controllers.

As used herein, an indicator may be said to be associated with a particular EVSE and/or charger if it is relatively closer to that EVSE or charger than other EVSEs or chargers.

In some implementations, the one or more indicators 120 may be incorporated into a user interface 296 of the EVSE 110a. The user interface 296 may include a touchscreen, button panel or application. The user interface 296 may flash or blink to notify the customer to use the selected EVSE. In some implementations, the user interface 296 may notify which of the one or more EVSE is selected by the one or more controllers to provide electric energy at a faster rate. In some implementations, the user interface 296 may display the charging speed of the EVSE 110a. In some implementations, the user interface 296 may alert to the customer that the EVSE the customer is in close proximity does not offer the most optimal charge and instruct the customer to proceed to the most optimal EVSE.

In some implementations, the one or more indicators 120 may be located in the EV. For example, the one or more indicators 120 may be located the cabin or interior of the EV. The one or more controllers 102 of FIG. 1, using a communications module, may communicate with the one or more indicators 120 found in the cabin or interior of the EV.

In some implementations, the one or more indicators 120 may include a mobile device (not shown). The mobile device and the EVCS 100 may be connected by a wireless connection over one or more wireless protocols, such as Bluetooth™, Wi-Fi™, Near-Field Communication (NFC), or another method using the communications module. For example, the one or more indicators 120 on the mobile device may display a message identifying which one or more EVSE is selected to be used next.

In some implementations, the one or more indicators 120 may be a series of light bars. In some implementations, the one or more indicators 120 may be a speed indicator, for example, indicating expected charging speed of the EVSE.

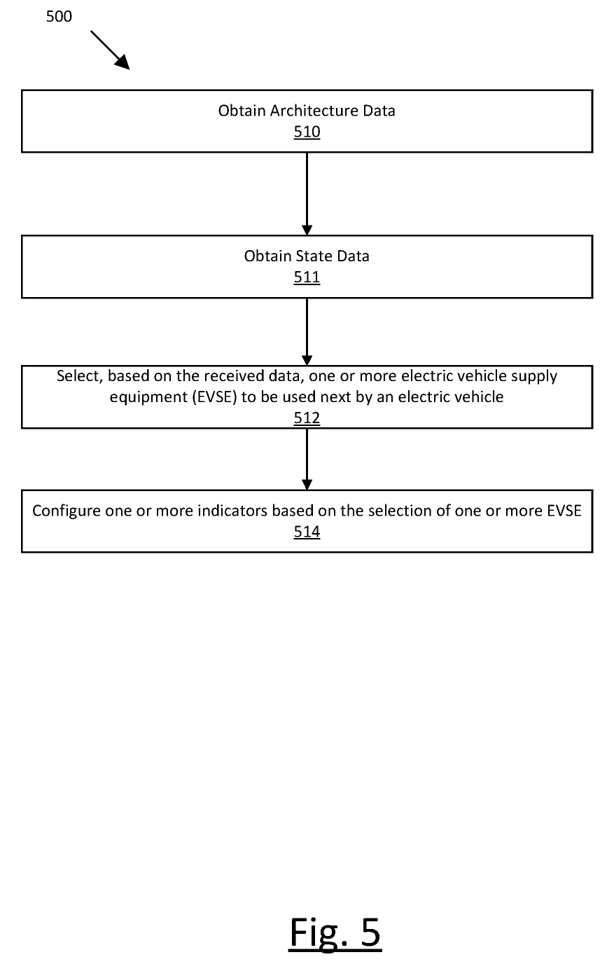

Reference is now made to FIG. 5 which illustrates an example method 500 for electric vehicle load balancing. The method 500 for electrical vehicle loading balancing may involve controlling one or more indicators to indicate which of the available EVSEs (and/or chargers) should be used. The method 500 may be implemented by a computing device having suitable processor-executable instructions for causing the computing device to carry out the described operations. The method 500 may be implemented, in whole or in part, by one or more controllers. In at least some implementations, the method 500 may be performed by the EVCS.

Prior to performance of the method 500, architecture data may be stored. The architecture data may, for example, be stored in a memory that is associated with the EVCS. For example, the architecture data may be stored in or retrievable via a memory module of the EVCS. The architecture data is data that defines an architecture of the EVCS. For example, the architecture data may include data that indicates a system architecture associated with the EVCS or a portion of the EVCS. The architecture data may indicate, for each EVSE and/or charger, one or more components that the EVSE and/or charger is coupled to. This architecture data may indicate the capacity of such components, such as an amperage or other rating for the components. This may be the maximum amperage rating for the component.

By way of example, the components may include electrical supply components and/or electrical distribution equipment, such as the breakers, subpanels, or electrical phases (e.g., in some instances it may indicate two phases that an EVSE/charger is connected to in a three phase system). The architecture data may also indicate which EVSE and/or chargers are connected to common components. For example, it may be that two chargers and/or EVSE are connected to a common breaker and those EVSE/chargers must, therefore, operate so as to not exceed an amperage defined for the breaker. When one of the EVSE/chargers is connected to component that another of the EVSE/chargers is also connected to, that EVSE/charger may charge at a reduced rate since the EVSE/chargers effectively share the maximum rating and must operate so that they do not jointly exceed the rating. When one of those two EVSE/chargers is not in use, the other of those EVSE/chargers may operate at a higher rate since sharing of the rating is no longer required.

The architecture data may be defined at the time of installation and/or deployment of the EVCS. For example, the architecture data may be defined based on input received via an input interface from an installer. The installer may, for example, define which of the EVSE/chargers share electrical components and the rating of such electrical components. While not illustrated in FIG. 5, in some implementations of the method, steps of receiving such input, preparing the architecture data and/or storing the architecture data may be included.

In operation 510, the one or more controllers may retrieve or receive architecture data from the memory module of the EVCS. As noted above, the architecture data may include information regarding the electrical supply components, electrical distribution equipment, such as the breakers, subpanels, or electrical phases.

In some cases, the one or more controllers may retrieve architecture data from memory defining which EVSE are connected to which breakers, sub-panels and/or electrical phases. The architecture data may include maximum load information for the various breakers, sub-panels and/or electrical phases or for each individual EVSE.

In some implementations, the architecture data retrieved by the one or more controllers may include the power rating of the EVSE.

At operation 511, the one or more controllers may retrieve or receive state data. The state data may represent a charging state or charging information for one or more of the EVSE and/or chargers. For example, the state data may indicate which of the EVSE and/or chargers are currently in use. The state data may, additionally or alternatively, indicate a rate of charge for an EVSE/charger, a requested power parameter for an EV that is being serviced by an EVSE/charger, etc. By way of example, the requested power parameter for the EV may indicate a desired charging speed for the EV, a maximum charging speed for the EV, etc.

The EVCS may monitor the state data continuously or upon occurrence of a triggering condition. For example, the EVCS may coordinate the delivery of power across all EVSE/chargers and it may, therefore, monitor all charging states across all EVSE/chargers.

In some implementations, the one or more controllers may receive state data or other data from which state data is generated from various sources, such as the electrical supply components, the electrical distribution equipment, one or more sensors, architecture data of the plurality of EVSE and the electrical supply components, and EVs in close proximity to the plurality of EVSE. The state data of the plurality of EVSE may be stored in the memory module of the EVCS. The state data of the plurality of EVSE may be updated from time to time in the memory module of the EVCS. The updates to the state data may be made by over-the-air updates using the communication module of the EVCS.

In some implementations, the one or controllers may receive state data from the one or more sensors. The one or more sensors may be monitoring the plurality of electrical supply components. The one or more controllers may receive data or input from the EVSE. In some cases, the one or more controllers may receive data or input from power conversion equipment, charging controllers, connectors and cables, safety devices, and communication modules.

In some cases, the one or more controllers may retrieve state data from EVs in close proximity to the EVSE. For example, using a communication module of the EVCS, the one or more controllers may receive data from EVs in close proximity wirelessly through a network. In some other examples, the one or more controllers may receive state data from the EVs charging at the EVSEs through the connectors. The state data may include information regarding an EV’s battery, such as charging state, temperature, and battery capacity. The state data may include how much power the EV requires from the EVSE.

Accordingly, at the operation 511, the controller may retrieve the state data. In some implementations, the state data retrieved by the one or more controllers may include the charging power level, the charging power supplied to an EV during a charging session, the charging rate of an EV during a charging session, the voltage and current levels being delivered to an EV during a charging session, the charging time of EVs at the EVSE and the energy delivered at the EVSE during a charging session.

In operation 512, the one or more controllers may select one or more of the plurality of EVSE to be used next by an electric vehicle. This selection may be made based on the architecture data. This selection may be made based on the state data. In making the selection, in at least some situations, the one or more controllers may determine that a particular one of the EVSE/chargers should be used by a next vehicle. The one or more controllers may determine that a particular one or more of the EVSE/chargers, which are not already in use and which are functionally operable (e.g., which are not broken or otherwise rendered unusable), should not be used.

The one or more controllers may select the one or more EVSE based on load balancing. For example, the one or more controllers may select one or more EVSE based on attempting to keep the load of the breakers, subpanels or electrical phases from being overloaded or underutilized. In some implementations, the one or more controllers may select the one or more EVSE based on increasing the total power output or charging speed of all the EVs connected to the plurality of EVSE and the next EV requiring access to an EVSE.

In some implementations, the one or more controllers may analyze the data, input and/or output from the plurality of electrical supply components, the electrical distribution equipment, the one or more sensors, the plurality of EVSE, a present load at each EVSE that is in use, the architecture data, and/or the maximum load information. The one or more controllers, using the data collected, may assess, and determine which of the plurality of EVSEs has the fastest available charging speeds.

In some implementations, the one or more controllers may select one or more EVSEs for the next EV to use based on trying to evenly distribute the load or power output to one or more EVs already connected to the EVSC and the next EV. In some cases, the one or more controllers may select one or more EVSEs for the next EV to use based on maximizing the power output for all EVs charging or connected to the EVSC. In some cases, the one or more controllers may select one or more EVSEs for the next EV to use based on the load of the breaker, subpanel, or electrical phase of the one or more EVSEs.

In some cases, the electrical supply components may include protection devices, such as fuses, circuit breakers and surge protectors. In some implementations, the one or more controllers may select one or more EVSEs for the next EV to use based on preventing the protection devices from triggering. That is, the controller may make the selection to try to avoid such triggering or activation of the protection devices. Accordingly, the one or more controllers may be attempting to protect the electrical supply components, electrical distribution equipment and the EVSEs from overloads, short circuits and/or voltage surges.

In some cases, based on the determination of which of the plurality of EVSEs have the fastest charging speeds, the one or more controllers may be configured to select one or more of the EVSE to be used by the next EV requiring access to one of the EVSE. In some cases, the one or more controllers may monitor which of the EVSEs are in use and select at least one of the EVSE that is currently not in use. In some cases, all the EVSEs available at the EVSC may be in use. Accordingly, the one or more controllers may monitor the EVSE that are in use and may pre-select one or more of the EVSEs to be used.

In some cases, the selection may be made to select an EVSE that could draw maximal power based on the current load at each EVSE already in use and/or based on the rating for the various breakers, subpanels, or electrical phases, taking into account a safety buffer at some instances. The safety buffer may include overload protection, short circuit protection, ground fault protection, surge protection, arc fault protection and temperature protection.

In some implementations, the one or more controllers may select two or more EVSE. For example, the selection may determine that a next vehicle should be charged using an EVSE coupled to a particular breaker, subpanel or electrical phase and there may be more than one such EVSE. In some cases, the next vehicle should be directed to either one of the EVSE coupled to the selected breaker, subpanel or electrical phase. Put differently, the selection of one or more EVSE may involve selecting a breaker, subpanel and/or electrical phase.

In some cases, the one or more controllers may identify the one or more EVSE whose use will manage a load across the plurality of electrical supply components includes identifying a breaker having a greatest available load based on current load data (such as state data) and identifying an EVSE associated with the identified breaker that is available for use based on system configuration data (such as architecture data). The breaker may be a main circuit breaker, an AC circuit breaker, a DC circuit breaker, a ground fault circuit interrupter breaker, a residual current circuit breaker, an arc fault circuit interrupter breaker, and an isolating circuit breaker.

In some cases, the one or more controllers may identify the one or more EVSE whose use will manage a load across the plurality of electrical supply components includes identifying a subpanel having a greatest available load based on current load data and identifying an EVSE associated with the identified sub-panel that is available for use based on system configuration data, such as architecture data. The subpanel may be a distribution panel, a charging equipment subpanel, a metering subpanel, a control and monitoring subpanel, an auxiliary subpanel, an emergency power subpanel, and an isolation subpanel.

In some cases, the one or more controllers may identify the one or more EVSE whose use will manage a load across the plurality of electrical supply components includes identifying a phase having a greatest available load based on current load data and identifying an EVSE associated with the identified phase that is available for use based on system configuration data, such as architecture data. The phase may be a single-phase or three-phase power configuration.

In operation 514, the one or more controllers may selectively control one or more of the indicators. The selection of the one or more indicators may be based on the selection of the one or more EVSE from operation 512. The indicators may each correspond to the one or more EVSE. For example, each indicator may be associated with each EVSE.

The one or more controllers may cause one or more of the indicators to activate. Put differently, the one or more controllers may provide an output to control the one or more indicators. The one or more controllers may control the one or more indicators to indicate that the selected one or more EVSEs is to be used by the next vehicle requiring access.

In some cases, the one or more indicators may include a plurality of lights, each of the plurality of lights situated in proximity and associated with a separate one of the EVSE.

In some cases, the one or more controllers may control the one or more indicators by adjusting a brightness of the one or more indicators so that the one of the lights that is associated with the selected EVSE is relatively brighter than one or more of the lights associated with one or more of the non-selected EVSE. The brightness of the one or more indicators may depend on the geolocation of the EVSC or the weather conditions at the EVSC. The brightness of the one or more indicators may be automatically adjusted based on the environment.

In some cases, the one or more controllers controlling the one or more indicators may include adjusting a color of the one or more indicators so that one of the lights that is associated with the selected EVSE has a color that distinguishes from a color of one or more of the lights associated with one or more of the non-selected EVSE. For example, the indicator of the selected EVSE displays a green color and the other indicators display a red, yellow, or orange color.

In some cases, each of the one or more indicators is situated in proximity and associated with a separate one of the EVSE. Controlling the one or more indicators may include causing the one or more indicators associated with the selected EVSE to display an animation that animates at a greater rate than a corresponding animation displayed on one or more of the EVSE apart from the selected EVSE. For example, the animation or the corresponding animation may include arrows pointing at the one or more selected EVSE, the letter “X” at the one or more unselected EVSE, and a particular pattern of flashing lights at the selected or unselected EVSE. The one or more indicators may be located on the EVSE. The one or more indicators may be located on the EV charging spot. The one or more indicators may be located on third-party fixtures, for example, if the EV charging spot is in an underground parking lot. The greater rate may be based on the speed of the animation or the number of times the animation repeats.

References to EVSE herein may also refer to EV chargers.

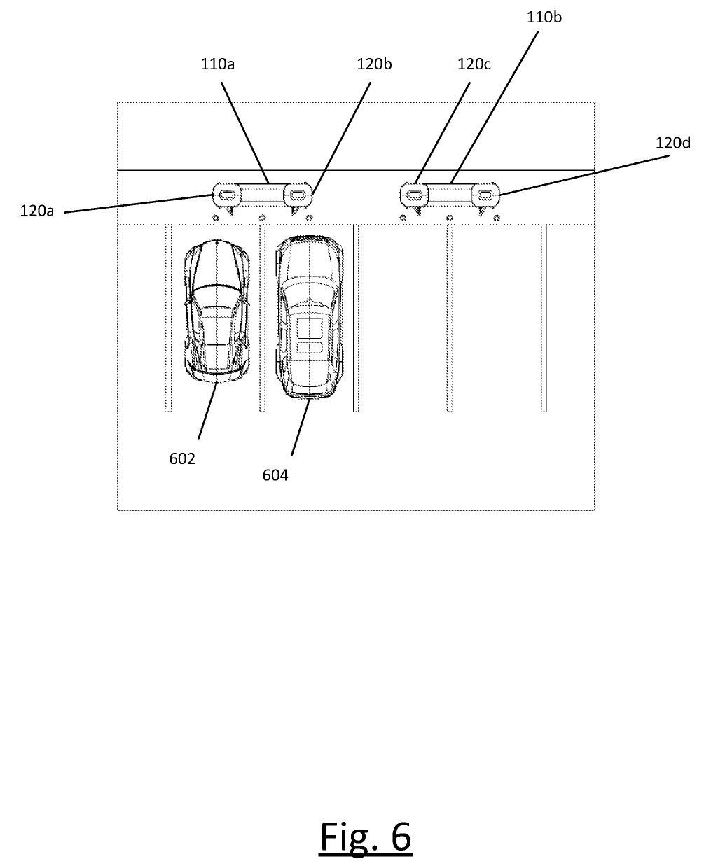

Reference is now made to FIG. 6 which illustrates an example placement or allocation of EVs at the EVCS 100. For example, a first EV 602 and a second EV 604 have been directed to the selected EVSE 110a by an indicator 120a and an indicator 120b. In this case, the selection of the EVSE 110a may have been determined by the one or more controllers based on the load balancing method described above. In some cases, the indicators 120c, 120d may be warning the first EV 602 and second EV 604 to avoid EVSE 110b by displaying a warning light, such as red, yellow, or orange.

The above discussed embodiments are considered to be illustrative and not restrictive. Certain adaptations and modifications of the described embodiments may be made. All such modification, permutations and combinations are intended to fall within the scope of the present disclosure.

What is claimed is:

1. An electric vehicle charging system comprising:
a plurality of electric vehicle supply equipment (EVSE) coupled to a plurality of electrical supply components; and
one or more controllers coupled to the plurality of EVSE and one or more indicators for indicating one or more of the plurality of EVSE that are to be used by a next electric vehicle requiring access to one of the plurality of EVSE, the one or more controllers configured to:
select one or more of the plurality of EVSE to be used by the next electric vehicle by identifying the one or more of the plurality of EVSE whose use will manage a load across the plurality of electrical supply components; and
control the one or more indicators to indicate that the one or more of the plurality of EVSE is to be used by the next electric vehicle.

2. The electric vehicle charging system of claim 1, further comprising:
the one or more indicators for indicating one or more of the plurality of EVSE that are to be used by the next electric vehicle.

3. The electric vehicle charging system of claim 1, wherein the one or more indicators include one or more lights, each of the one or more lights situated in proximity and associated with a separate one of the plurality of EVSE.

4. The electric vehicle charging system of claim 3, wherein controlling the one or more indicators includes adjusting a brightness of the one or more indicators so that the one or more lights associated with selected one or more of the plurality of EVSE is relatively brighter than the one or more lights associated with non-selected one or more of the plurality of EVSE.

5. The electric vehicle charging system of claim 3, wherein controlling the one or more indicators includes adjusting a color of the one or more indicators so that the one or more lights associated with selected one or more of the plurality of EVSE has a first color that distinguishes from a second color of the one or more lights associated with non-selected one or more of the plurality of EVSE.

6. The electric vehicle charging system of claim 1, wherein each of the one or more indicators is situated in proximity and associated with a separate one of the plurality of EVSE and wherein controlling the one or more indicators includes causing the one or more indicators associated with selected one or more of the plurality of EVSE to display an animation that animates at a greater rate than a corresponding animation displayed on non-selected one or more of the plurality of EVSE.

7. The electric vehicle charging system of claim 1, wherein identifying the one or more EVSE whose use will manage a load across the plurality of electrical supply components includes identifying a breaker having a greatest available load based on current load data and identifying an EVSE associated with an identified breaker that is available for use based on system configuration data.

8. The electric vehicle charging system of claim 1, wherein identifying the one or more EVSE whose use will manage a load across the plurality of electrical supply components includes identifying a sub-panel having a greatest available load based on current load data and identifying an EVSE associated with an identified sub-panel that is available for use based on system configuration data.

9. The electric vehicle charging system of claim 1, wherein identifying the one or more EVSE whose use will manage a load across the plurality of electrical supply components includes identifying a phase having a greatest available load based on current load data and identifying an EVSE associated with an identified phase that is available for use based on system configuration data.

10. The electric vehicle charging system of claim 1, wherein the one or more indicators is in a cabin of the next electric vehicle.

11. A computer-implemented method for load balancing, the method comprising:
selecting one or more electric vehicle supply equipment (EVSE) to be used by a next electric vehicle requiring access to the one or more EVSE by identifying the one or more EVSE whose use will manage a load across a plurality of electrical supply components; and
controlling one or more indicators to indicate that the one or more EVSE are to be used by the next electric vehicle.

12. The method of claim 11, includes the one or more indicators for indicating the one or more EVSE that are to be used by the next electric vehicle.

13. The method of claim 11, wherein the one or more indicators include one or more lights, each of the one or more lights situated in proximity and associated with a separate one of the one or more EVSE.

14. The method of claim 13, wherein controlling the one or more of the indicators includes adjusting a brightness of the one or more indicators so that the one or more lights associated with selected one or more EVSE is relatively brighter than the one or more lights associated with non-selected one or more EVSE.

15. The method of claim 13, wherein controlling the one or more indicators includes adjusting a color of the one or more indicators so that the one or more lights that is associated with selected one or more EVSE has a first color that distinguishes from a second color of the one or more lights associated with non-selected one or more EVSE.

16. The method of claim 11, wherein each of the one or more indicators is situated in proximity and associated with a separate one of the EVSE and wherein controlling the one or more indicators includes causing the one or more indicators associated with selected EVSE to display an animation that animates at a greater rate than a corresponding animation displayed on non-selected EVSE.

17. The method of claim 11, wherein identifying the one or more EVSE whose use will manage a load across the plurality of electrical supply components includes identifying a breaker having a greatest available load based on current load data and identifying an EVSE associated with an identified breaker that is available for use based on system configuration data.

18. The method of claim 11, wherein identifying the one or more EVSE whose use will manage a load across the plurality of electrical supply components includes identifying a sub-panel having a greatest available load based on current load data and identifying an EVSE associated with an identified sub-panel that is available for use based on system configuration data.

19. The method of claim 11, wherein identifying the one or more EVSE whose use will manage a load across the plurality of electrical supply components includes identifying a phase having a greatest available load based on current load data and identifying an EVSE associated with an identified phase that is available for use based on system configuration data.

20. The method of claim 11, wherein the one or more indicators is in a cabin of the next electric vehicle.
